(19) United States
(12) Patent Application Publication
(10) Pub. No.: US 2019/0289858 A1
(43) Pub. Date: Sep. 26, 2019

(54) Baking Oven With Modular Heating Element

(71) Applicant: HAAS FOOD EQUIPMENT GMBH, Leobendorf (AT)

(72) Inventors: Stefan Jiraschek, Königsbrunn (AT); Markus Scheller, Bruderndorf (AT); Daniel Süss, Tulln an der Donau (AT); Karl Miller, Wien (AT)

(73) Assignee: HAAS FOOD EQUIPMENT GMBH, Leobendorf (AT)

(21) Appl. No.: 16/339,358

(22) PCT Filed: Oct. 4, 2017
(86) PCT No.: PCT/EP2017/075105

§ 371 Date: Apr. 4, 2019

(30) Foreign Application Priority Data
Oct. 4, 2016 (EP) 16192160.6

(51) Int. Cl. A21B 5/02; A21B 1/28; A21B 1/48; A21B 1/14; A21B 3/02; A21B 3/07; A21B 3/13; A21B 3/18

(52) U.S. Cl. CPC A21B 5/023; A21B 1/28; A21B 1/48; A21B 3/18; A21B 3/02; A21B 3/07; A21B 3/135; A21B 1/14

(57) ABSTRACT

An oven for producing baked products has a plurality of baking irons (3) that are openable and closable and arranged in an elongated machine frame (1) along a continuous conveyor (2) that passes successively through a baking dough application region, a closing region, a baking area (4) for baking the baked products in which at least one heating arrangement (5) is provided for heating, an opening region, and a baked product removal region. The heating arrangement (5) comprises at least one heating element (6) that supplies thermal energy into the baking area (4). The oven has a first heating element receiving portion (14) at which the heating element (6) is detachably connected to the machine frame (1) via a guide device (15). The guide device (15) has at least one guide rail (16) and at least one guide element (17) that can be moved along the guide rail (16).

### CROSS-REFERENCE TO RELATED APPLICATION(S)

This application is the National Stage of International Patent Application No. PCT/EP2017/075105 filed on Oct. 4, 2017, which claims priority from European Patent Application No. 16192160.6 filed on Oct. 4, 2016, both of which are herein incorporated by reference herein in their entireties.

### BACKGROUND

### 1. Field of the Invention

The invention relates to a baking oven. In particular, the invention relates to a baking oven for producing baked, preferably edible, products.

### 2. State of the Art

A baking oven for producing baked products has multiple baking tongs which are provided in an elongated machine frame along an endless conveyor, can be opened and closed, are arranged in series and one after the other pass through a baking mass application area for applying a baking mass to an opened baking tong, a closing area for closing the baking tongs, a baking chamber heated by means of a heating arrangement for baking the baked products in the closed baking tongs, an opening area for opening the baking tongs and a baked product removal area for removing the baked products from the opened baking tongs.

Baking ovens of this kind are in particular used for producing wafer products such as flat wafers or hollow wafers.

Similar baking ovens are known and published in different embodiments.

For example, baking ovens are known in which the heating of the baking chamber is accomplished by means of gas burners which are arranged along the entire baking chamber, following the endless conveyor. Furthermore, baking ovens are known in which the heating arrangement comprises heating elements in the form of radiant burners for heating the baking tongs. Depending on the design, the heating power of these heating elements can be so high that it is not necessary to provide for heating along the entire extension of the endless conveyor. Instead, it suffices to provide these radiant burners in a section-wise manner along the endless conveyor.

However, baking ovens with conventional gas burners are also known, in which the gas burners cover only a section of the baking chamber.

Ovens of this type have surprisingly shown that the position of the heating elements influences the baked product to be produced. It may be necessary, for example, to vary or adjust the position of the heating elements for different baked products produced in one baking oven.

In addition, there is a need for baking ovens that are easy to maintain. In particular the maintenance of the gas burners in conventional baking ovens is time-consuming as the burner arrangements are usually fixedly connected to the machine frame via screw connections. Before such a gas burner can be de-mounted or maintained the production has to be stopped. Then, one has to wait until the gas burner and in particular the entire baking oven has cooled down. Only then, the gas burners can be removed, repaired or maintained.

### SUMMARY

Therefore, the object of the invention is to overcome the disadvantages of the prior art and, in particular, to provide a baking oven that allows its heating elements to be handled flexibly.

The object according to the invention is in particular solved by the hereinafter described features.

Optionally, the invention relates to a baking oven for producing baked, preferably edible, products, comprising multiple baking tongs which are provided in an elongated machine frame along an endless conveyor, can be opened and closed, are arranged in series and one after the other pass through
a baking mass application area for applying a baking mass to an opened baking tong,
a closing area for closing the baking tongs,
a baking chamber for baking the baked products in the closed baking tongs, in which at least one heating arrangement is provided for heating the baking tongs located inside the baking chamber,
an opening area for opening the baking tongs
and a baked product removal area for removing the baked products from the opened baking tongs,
   wherein the heating arrangement comprises at least one heatable or heated heating element for supplying thermal energy to the baking chamber.

Optionally, it may be provided that at least one upper heating element holder is provided, on which the heating element is releasably connected to the machine frame via a connection device, that the baking chamber is surrounded by a housing, that the housing has an opening in the area of the upper heating element holder that is closed or can be closed by means of a removable lid and that the opening is at least partly covered by the heating element.

Optionally, it may be provided that the connection device comprises at least one support connected to the machine frame for vertically supporting the heating element.

Optionally, it may be provided that the connection device comprises at least one position centering means for centering the position of the heating element horizontally in relation to the machine frame.

Optionally, it may be provided that the heating element is arranged on the removable lid or that the removable lid is at least partly formed by the heating element.

Optionally, it may be provided that the heating element is arranged on the removable lid or that the removable lid is at least partly formed by the heating element and that the lid is releasably connected to the machine frame and/or the housing via the connection device.

Optionally, it may be provided that a plurality of upper heating element holders is provided, that the housing has one or more opening/s in the area of the upper heating element holders that is/are closed or can be closed by means of one or more removable lid/s and that the heating element is optionally connected or connectable to the machine frame via the connection device on one of the upper heating element holders.

Optionally, it may be provided that the heating arrangement comprises a plurality of heating elements, that a plurality of heating element holders are provided and that the heating elements are releasably connected to the machine frame via connection devices.

Optionally, it may be provided that the upper heating element holder/s is/are arranged above the endless conveyor.

Optionally, it may be provided that the baking oven comprises a second heating element holder and optionally at least one additional heating element holder and that the heating element is connectable to the machine frame, optionally at the first heating element holder, at the second heating element holder or optionally at the at least one additional heating element holder, via a or the connection device.

Optionally, it may be provided that the heating element is configured as a gas-powered radiant burner or that the heating elements are configured as gas-powered radiant burners and in particular that the heating element/s is/are configured as downwardly directed gas-powered radiant burner/s.

Optionally, it may be provided that the baking oven comprises a first lower heating element holder on which a lower heating element is releasably connected to the machine frame via a guiding device, wherein the guiding device has at least one guiding rail and at least one guiding element which is movable along the guiding rail.

Optionally, it may be provided that the guiding device is configured as a drawer for the guided insertion and removal of the lower heating element into the baking oven/from the baking oven.

Optionally, it may be provided that the guiding device comprises at least two guiding elements and that the guiding elements are configured as rotatably mounted rollers.

Optionally, it may be provided that the guiding device comprises two guiding rails that are parallel to one another and that the guiding rails and/or an insertion direction is/are transverse to the direction of longitudinal extent of the elongated machine frame and transverse to the direction of movement of the baking tongs provided along the endless conveyor.

Optionally, it may be provided that the baking oven comprises a second lower heating element holder and optionally at least one additional lower heating element holder and that the heating element is connectable to the machine frame, optionally at the first lower heating element holder, at the second lower heating element holder or optionally at the at least one additional lower heating element holder, via a or the guiding device.

Optionally, the invention relates to a baking oven for producing baked, preferably edible, products, comprising multiple baking tongs which are provided in an elongated machine frame along an endless conveyor, can be opened and closed, are arranged in series and one after the other pass through
a baking mass application area for applying a baking mass to an opened baking tong,
a closing area for closing the baking tongs,
a baking chamber for baking the baked products in the closed baking tongs, in which at least one heating arrangement is provided for heating the baking tongs located inside the baking chamber,
an opening area for opening the baking tongs
and a baked product removal area for removing the baked products from the opened baking tongs,
   wherein the heating arrangement comprises at least one heatable or heated heating element for supplying thermal energy to the baking chamber.

Optionally, it may be provided that the baking oven comprises a first heating element holder on which the heating element is releasably connected to the machine frame via a guiding device, wherein the guiding device has at least one guiding rail and at least one guiding element which is movable along the guiding rail.

Optionally, it may be provided that the guiding device is configured as drawer for the guided insertion and removal of the heating element into the baking oven/from the baking oven.

Optionally, it may be provided that the guiding device comprises two guiding rails that are parallel to one another and at least two guiding elements, wherein the two guiding elements are respectively guided on a guiding rail for the guided insertion and removal of the heating element into the baking oven/from the baking oven.

Optionally, it may be provided that the guiding elements are configured as rotatably mounted rollers.

Optionally, it may be provided that each of the guiding rails has a first guide contour, that the guiding element is guided along the guide contour, that the guide contour has an insertion section extending along the insertion direction for the guided insertion and removal of the heating element into the baking oven/from the baking oven, and that the guide contour has an engagement section deviating from the insertion direction for engaging the heating element in the baking oven.

Optionally, it may be provided that each of the guiding rails has a first guide contour and a second guide contour, that two guiding elements are provided which are guided along the guide contour, that at least one of the guide contours of a guiding rail has an insertion section extending along the insertion direction for the guided insertion and removal of the heating element into the baking oven/from the baking oven, and that at least one of the guide contours of the same guiding rail has an engagement section deviating from the insertion direction for engaging the heating element in the baking oven.

Optionally, it may be provided that the guiding rails and/or the insertion direction are transverse to the direction of longitudinal extent of the elongated machine frame and transverse to the direction of movement of the baking tongs provided along the endless conveyor.

Optionally, it may be provided that the baking oven comprises a second heating element holder and optionally at least one additional heating element holder and that the heating element is connectable to the machine frame, optionally at the first heating element holder, at the second heating element holder or optionally at the at least one additional heating element holder, via a or the guiding device.

Optionally, it may be provided that the baking chamber is surrounded by a housing, that the housing comprises flaps that can be opened and closed, in particular lateral doors, that the heating element holder is arranged in the area of a flap so that the heating element can be inserted into the baking chamber through the opened flap, or that all the heating element holders are respectively arranged in the area of a flap so that the heating element can be inserted into one of the heating element holders of the baking chamber through an opened flap.

Optionally, it may be provided that the heating arrangement comprises a plurality of heating elements, that a plurality of heating element holders is provided and that the heating elements are releasably connected to the machine frame via the guiding devices.

Optionally, it may be provided that the endless conveyor extends along an upper transport surface and along a lower transport surface that is vertically spaced away from the upper transport surface, and that the heating element holder/s is/are arranged between the upper transport surface and the lower transport surface.

Optionally, it may be provided that the heating element is configured as gas-powered radiant burner or that the heating elements are configured as gas-powered radiant burners and in particular that the heating element/s is/are configured as downwardly directed gas-powered radiant burner/s.

Optionally, it may be provided that
at least one upper heating element holder is provided on which an upper heating element is releasably connected to the machine frame via a connection device,
that the baking chamber is surrounded by the housing,
that the housing has an opening in the area of the upper heating element holder that is closed or can be closed by means of a removable lid,
and that the opening is at least partly covered by the upper heating element.

Optionally, it may be provided that the connection device comprises at least one support connected to the machine frame for vertically supporting the upper heating element.

Optionally, it may be provided that
the upper heating element is arranged on the removable lid
or that the removable lid is at least partly formed by the upper heating element.

The baking oven according to the invention is in particular characterized by at least one modular heating element. This heating element can be easily removed, inserted and/or maintained. Preferably, at least two heating elements are provided, wherein one heating element is provided above the endless conveyor and the other heating element is arranged between the upper transport surface and the lower transport surface of the endless conveyor. The endless conveyor is preferably diverted at a front point of diversion and a back point of diversion, whereby the baking tongs connected to the endless conveyor are diverted at these points of diversion.

The heating elements are preferably configured as downwardly directed radiant burners. A heating element can in particular be described as being directed downwardly if the effective direction of the heat emission or the heat radiation, respectively, is directed downwardly. In radiant burners, for example, the heat radiation is considerably or mainly emitted in the direction of radiation, i. e. downwardly. By means of the two heating elements that are arranged at different locations, the upper plate and the lower plate of the baking tong can be heated one after the other.

Optionally, it may be provided that the baking oven comprises a heating element holder on which the heating element is releasably connected to the machine frame via a guiding device. This guiding device preferably acts as drawer for the guided insertion and removal of the heating element. This guiding device allows the heating element to be inserted and removed quickly and in an uncomplicated manner. Such a heating element holder with a guiding device can, for example, be arranged above the endless conveyor and/or between the two transport surfaces of the endless conveyor.

Optionally, an opening that is closed or can be closed by means of a lid is provided in the area of an upper heating element holder, this opening being at least partly covered by a heating element. According to this embodiment the housing of the baking oven has an upper opening. A heating element can be inserted or deposited into this opening from above. Therefore, the heating element can in particular be accessed from above, inserted from above and removed from above. Preferably, the heating element is part of a lid, which can be used to close the opening of the baking chamber. Also this design enables the heating element to be easily removed and maintained.

According to a preferred embodiment, the upper heating elements are connected to the machine frame or the housing, respectively, via a connection device so that an upper opening is at least partly covered. According to this embodiment, each heating element arranged between the two transport surfaces of the endless conveyor can be configured as a heating element connected to the machine frame or the housing, respectively, via a guiding device.

Alternatively, however, also all heating elements can be connected to the machine frame via guiding devices; hence, all the heating elements can be inserted or introduced from the side.

According to a preferred embodiment, the baking oven has a plurality of heating element holders. A heating element holder designates in particular a part of the baking oven which is configured for receiving or holding a heating element. The heating element holder can, for example, comprise parts of the guiding device or parts of the connection device. According to an embodiment of the invention, more heating element holders than heating elements are provided so that a heating element can optionally be connected to the baking oven at different locations. This allows the heating characteristic of the oven to be easily changed, for example.

Furthermore, an additional heating element can be connected to the oven, inserted into or supplied to the oven at a vacant heating element holder, for example for maintaining a heating element that is already connected to the oven. Subsequently, the heating element to be maintained can be removed, wherein the heating power of the removed heating element can be compensated by the newly connected/inserted/supplied heating element.

This allows the heating power to be maintained during maintenance works, enabling the operation to continue with hardly any interruptions.

Preferably, the housing is provided with thermal insulation in all embodiments. Preferably, the housing is substantially closed in all embodiments and in particular configured with a closed bottom. Preferably, also the elements configured as lids and the elements configured as flaps are provided with thermal insulation.

According to a further embodiment a guiding device can be provided at an upper heating element holder so that the heating element can be inserted or removed, respectively, in a guided manner. In addition, a lid acting as a cover element can be provided which closes the baking chamber of the baking oven. This allows the lid to be removed in a first step so that the heating element can be inserted or introduced from above or from the side, respectively, along a substantially horizontal insertion direction. Optionally, a lowering of the heating element into the baking oven or into the baking chamber, respectively, is made possible by the section of the guide contour which leads to the engagement of the heating element. Subsequently, the introduced heating element can be covered by a lid from above, which closes the baking oven and the baking chamber.

### BRIEF DESCRIPTION OF THE DRAWINGS

Subsequently, the invention is described further by means of an exemplary embodiment.

FIG. 1 shows a schematic side view/sectional view of a possible design of a baking oven according to the invention.

FIG. 2 shows a schematic view of a sectional view according to section line A-A of FIG. 1.

FIG. 3 shows a schematic oblique view of relevant components of a baking oven according to the invention.

### DETAILED DESCRIPTION

Unless otherwise indicated, the numerals correspond to the following components: Machine frame 1, endless conveyor 2, baking tong 3, baking chamber 4, heating arrangement 5, heating element 6, heating element holder 7, connection device 8, housing 9, lid 10, opening 11, support 12, position centering means 13, first heating element holder 14, guiding device 15, guiding rail 16, guiding element 17, guide contour 18, insertion direction 19, insertion section 20, engagement section 21, first guide contour 22, second guide contour 23, direction of longitudinal extent (of the elongated machine frame) 24, second heating element holder 25, additional heating element holder 26, flap 27, upper transport surface 28, lower transport surface 29, pre-head 30, supply cabinet 31, port 32, service flap 33.

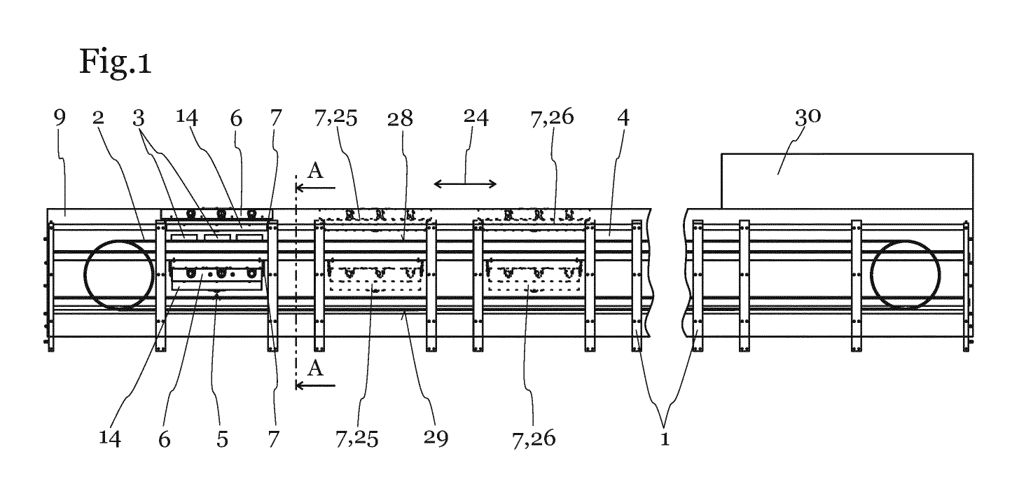

FIG. 1 shows a schematic, partially sectional side view of a baking oven according to the invention. The baking oven has an elongated shape extending along the direction of longitudinal extent 24.

The baking oven comprises an endless conveyor 2, on which lined-up baking tongs 3 are provided, wherein only a few baking tongs are shown for the sake of clarity. The endless conveyor 2 extends from a pre-head 30, in which the following are provided one after the other along the conveying direction of the endless conveyor 2 or the baking tongs 3, respectively: a device for opening the baking tongs 3, a baked product removal area for removing the baked products from the opening baking tongs 3, a baking mass application area for applying a baking mass to an opened baking tong 3, and a closing area for closing the baking tongs 3. These components of the pre-head correspond to the state of the art and are therefore not shown for the sake of simplicity. Once the baking tongs 3 are closed, the baking tongs 3 leave the pre-head 30 and enter into a baking chamber 4. This baking chamber 4 comprises at least one heating arrangement 5 for heating the baking tongs 3 located inside the baking chamber 4. The heating arrangement 5 comprises at least one heating element 6, wherein two heating elements 6 are provided according to the present embodiment. According to the present embodiment, the endless conveyor 2 extends along an upper transport surface 28 and along a lower transport surface 29. According to the present embodiment, a heating element 6 of the heating arrangement 5 is arranged above the upper transport surface 28.

Further, an additional heating element 6 of the heating arrangement 5 is provided between the upper transport surface 28 and the lower transport surface 29. The two heating elements 6 are preferably configured as downwardly directed heating elements. Preferably, the heating elements 6 of this embodiment are configured as radiant burners the heat radiation of which is directed downwardly to a large extent.

The heating elements 6 are respectively provided on a heating element holder 7. In addition to the heating element holders 7, on each of which one heating element 6 is provided, additional heating element holders 7 are provided, which are left free according to this embodiment. Hence, more heating element holders 7 than heating elements 6 are provided in the baking oven. This, for example, enables the burner characteristic to be changed by moving one heating element 6 from one heating element holder 7 to another heating element holder 7. In particular, at least one second heating element holder 25 or one further heating element holder 26, respectively, can be s provided.

In the present embodiment, the baking oven comprises a housing 9. This housing 9 surrounds at least the baking chamber 4. The housing 9 preferably also surrounds the pre-head 30. The housing 9 is preferably arranged on a machine frame 1.

The housing 9 is preferably configured as substantially closed. This means in particular that the housing 9 surrounds the baking chamber 4 in its entirety and thus delimits it in relation to the environment. However, openings may be present in the housing 9. In particular, at least one opening is provided in the wall between the pre-head 30 and the baking chamber 4, wherein the endless conveyor 3 is passed through this opening.

Preferably, the baking chamber 4 further comprises a vent for venting the combustion chamber gases and optionally an opening for supplying a convection flow. In the baking oven according to FIG. 1 heating elements 6 may be provided on the different heating element holders 7, in particular on the second heating element holder 25 and/or the additional heating element holder 26.

According to the present embodiment, the baking oven comprises a plurality of heating element holders 7, in particular a first heating element holder 14, a second heating element holder 25 and an additional heating element holder 26. In addition, one upper first heating element holder and one lower first heating element holder, one upper second heating element holder and one lower second heating element holder as well as one upper additional heating element holder and one lower additional heating element holder are provided respectively. Preferably, all the upper heating element holders are designed in such a way that the upper heating elements are lid-shaped or attached to a lid-shaped body. Preferably, all the lower heating element holders are designed in such a way that the lower heating element/s can be inserted from the side.

Along the extension of the baking oven, in particular along the direction of longitudinal extent 24, a plurality of heating element holders 7 is provided. In the area of each heating element holder a lid 10 may be provided for allowing the heating element 6 to be connected to the machine frame 1 or the housing 9, respectively, via a connection device 8. These lids 10 are delimited in their extension along the direction of longitudinal extent 24. In particular, their size slightly exceeds the size of the area of the heating element holder 7 so that the heating element 6 can be mounted on the baking oven from above. Preferably, all the lids 10 have the same dimensions so that their position can be chosen. Hence, a plurality of lids is provided, wherein these lids are only optionally provided with a heating element.

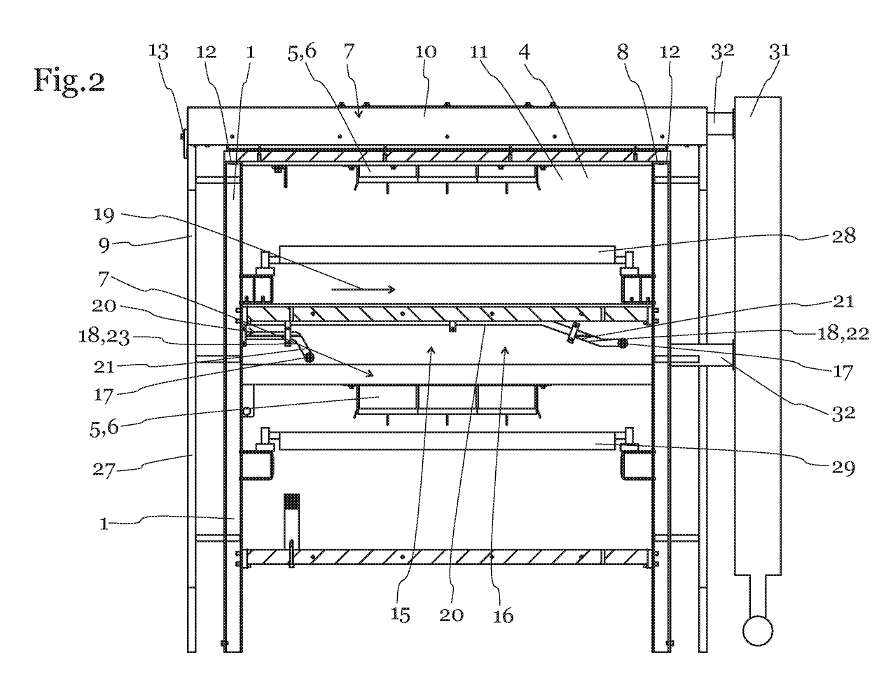

FIG. 2 shows a schematic sectional view of a baking oven according to section line A-A of FIG. 1. In the present view of FIG. 2, the direction of longitudinal extent 24 of the machine frame 1 extends in a projecting manner.

In the shown section of the baking oven a heating arrangement 5 with two heating elements 6 is provided. The baking chamber 4 is surrounded by a housing 9, wherein the housing 9 is supported by the machine frame 1. The housing 9 can optionally be part of the machine frame 1. The heating elements 6 are respectively arranged on a heating element holder 7. The upper heating element 6 is connected to the housing 9 or to the machine frame 1, respectively, via a connection device 8. The housing 9 comprises an opening 11 that can be closed by means of a lid 10. This opening 11 is at least partly covered by the heating element 6. In the present embodiment, the heating element 6 is arranged on the lid 10, in particular on the lower side of the lid, so that the heating element 6 closes the opening 11 together with the lid 10 and thus covers the baking chamber 4 from above. To this end, the connection device 8 comprises a support 12 onto which a part of the lid 10 or of the heating element 6 can be placed for supporting the arrangement. In addition, the connection device 8 comprises preferably at least one position centering means 13 which allows the position of the heating element 6, and in particular of the lid 10, to be horizontally centered in relation to the machine frame 1 or the housing 9, respectively.

This position centering means 13 may, for example, be configured as a centering rail, as can be seen in FIG. 2, for example. However, also centering bolts, for example, or other centering means may be provided.

In the present embodiment, the upper heating element 6 is configured as a lid-shaped body.

The baking oven further comprises a lower heating element 6 which is connected to the machine frame 1 via a guiding device 15. The guiding device 15 comprises a guiding rail 16 and at least one, preferably more, guiding element/s 17. In the present embodiment, four guiding elements 17 are provided, wherein only two guiding elements 17 are shown in the figure. In the present embodiment, the guiding rail 16 comprises two guide contours 18. The guiding rail 16 extends substantially along the insertion direction 19. The guide contour 18 comprises an insertion section 20 which follows the insertion direction 19. In addition, the guide contour 18 comprises an engagement section 21 deviating from the insertion direction 19.

In the present embodiment, a first guide contour 22 and a second guide contour 23 are provided. The two guide contours 22, 23 are in particular used for guiding different guiding elements 17. As in this embodiment, one guiding rail 16 each is preferably provided on both sides of the heating element 6. In particular, the guiding rails 16 can be symmetrical.

The guiding elements 17 are preferably configured as rollers and in particular as rotatably mounted rollers. This allows the friction between the guiding rail 16, in particular the guide contour 18, and the guiding element 17 to be decreased. The guiding elements preferably protrude from both sides of the heating element.

The used heating elements 6 can have a weight of several kilos. In particular, the heating may lead to thermal stresses and a clamping of the heating element in the guiding rails 16. By providing mounted rollers, the insertion and the removal of the heating elements 6 is facilitated.

The lower heating element 6 may be inserted and removed through a flap 27, which is for example configured as a lateral door of the oven.

Furthermore, the baking oven according to the invention may have a supply cabinet 31. This supply cabinet 31 is only shown schematically and can, for example, comprise ports for supplying the fuel and the primary oxygen or the primary air, respectively. The supply cabinet 31 is preferably configured as moveable supply cabinet and/or built in such a way that it can be easily moved and/or transported to the respective occupied heating element holder 7 by means of a transport trolley or crane, for connecting the heating elements 6 to the supply cabinet 31. The heating elements 6, for example, have ports 32 for the supply of the fuel mixture, which—as in the present embodiment of the lower heating element—for example extend through the housing 9 in order to be able to be connected to the supply cabinet 31 on the outside of the housing 9. The supply cabinet 31, for its part, is connected to a fuel pipe for being able to supply the fuel to the heating elements 6. Furthermore, ignition and monitoring electrodes are run and/or provided between the heat and the supply cabinet. These ignition and monitoring electrodes can be quickly loosened and re-connected without tools.

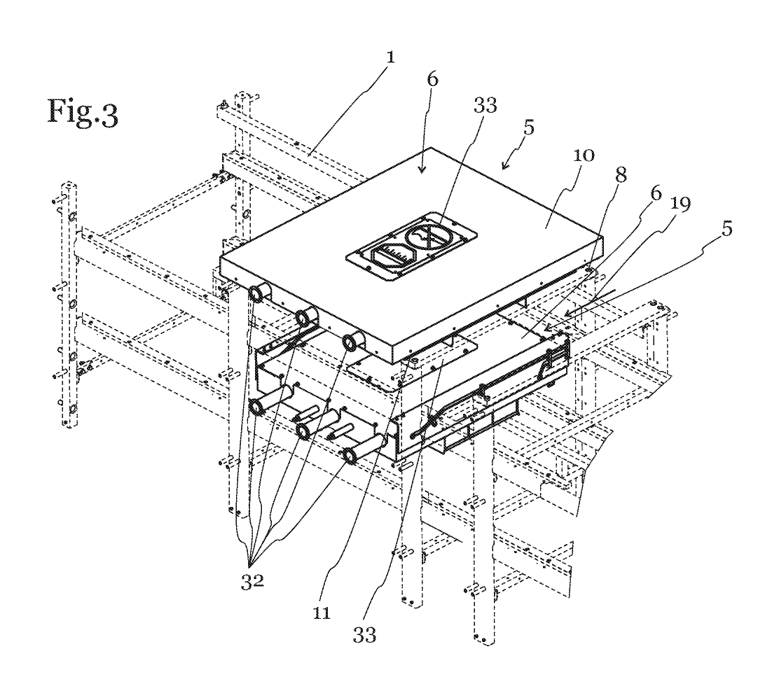

FIG. 3 shows an oblique view of parts of the baking oven of FIGS. 1 and 2, wherein no components are shown apart from the significant components of the heating arrangement 5 or the connection device 8 and the guiding device 15, respectively. The heating elements 6 are in turn connected to the machine frame 1 via the connection device 8 or the guiding device 15, respectively. The heating elements 6 have ports 32 for the connection to the supply cabinet 31, which is not shown. While the lower heating element 6 can be inserted into the baking oven in the insertion direction 19 and removed from the baking oven counter to the insertion direction 19, in the present embodiment, the upper heating element 6 is placed on the machine frame 1 from above in a lid-like manner, in order to particularly cover the opening 11 of the housing 9 (not shown). To this end, the heating element 6 is fixedly connected to a lid 10.

On the back sides of the heating elements 6, one service flap 33 each is provided. This service flap 33 allows components of the heating element, for example the ignition device, to be checked and maintained without having to dismantle the heating element 6 in its entirety.

According to a preferred embodiment the guiding elements 17, in particular four guiding elements 17, are provided on the heating element 6. According to this embodiment, the guiding rails 16 are preferably arranged on the machine frame 1. This allows the heating element 6 to be introduced into the baking oven or to be removed from the baking oven by guiding the guiding elements 17 along the guiding rails 16. The guiding elements 17 are configured as guiding elements 17 which jut out substantially transversely to the s insertion direction 19 and which, in particular, comprise rotatably mounted rollers. The rotational axis of these rollers preferably also extends transversely to the insertion direction 19.

However, it is basically also in keeping with the concept of the invention to provide the guiding elements 17 on the machine frame 1 and the guiding rails 16 on the heating element 6.

1.-15. (canceled)

16. A baking oven for producing baked edible products, comprising:
multiple baking tongs (3) which are provided in an elongated machine frame (1) along an endless conveyor (2), can be opened and closed, are arranged in series and one after the other proceed through a baking mass application area for applying a baking mass to an opened baking tong (3), a closing area for closing the baking tongs (3), a baking chamber (4) for baking the baked products in the closed baking tongs (3), in which at least one heating arrangement (5) is provided for heating the baking tongs (3) located inside the baking chamber (4), an opening area for opening the baking tongs (3), and a baked product removal area for removing the baked products from the opened baking tongs (3),
wherein the at least one heating arrangement (5) comprises at least one heatable or heated heating element (6) for supplying thermal energy to the baking chamber (4),
wherein the baking oven comprises a first heating element holder (14) on which the at least one heating element (6) is releasably connected to the machine frame (1) via a guiding device (15), wherein the guiding device (15) has at least one guiding rail (16) and at least one guiding element (17) which is movable along the guiding rail (16).

17. The baking oven according to claim 16, wherein the guiding device (15) is configured as a drawer for the guided insertion and removal of the at least one heating element (6) into the baking oven or from the baking oven.

18. The baking oven according to claim 16, wherein the guiding device (15) comprises two guiding rails (16) that are parallel to one another and at least two guiding elements (17), wherein the two guiding elements (17) are respectively guided on a guiding rail (16) for the guided insertion and removal of the at least one heating element (6) into the baking oven or from the baking oven.

19. The baking oven according to claim 16, wherein the guiding elements (17) are configured as rotatably mounted rollers.

20. The baking oven according to claim 16, wherein each of the guiding rails (16) has a first guide contour (22), the guiding element (17) is guided along the guide contour having an insertion section (20) extending along an insertion direction (19) for the guided insertion and removal of the at least one heating element (6) into the baking oven or from the baking oven, and the guide contour has an engagement section (21) deviating from the insertion direction (19) for engaging the heating element (6) in the baking oven.

21. The baking oven according to claim 16, wherein each guiding rail (16) has a first guide contour (22) and a second guide contour (23), and two guiding elements (17) are provided which are guided along the guide contours, at least one of the guide contours of a guiding rail (16) has an insertion section (20) extending along an insertion direction (19) for the guided insertion and removal of the heating element (6) into the baking oven or from the baking oven, and at least one of the guide contours of the same guiding rail (16) has an engagement section (21) deviating from the insertion direction (19) for engaging the heating element (6) in the baking oven.

22. The baking oven according to claim 16, wherein the guiding rails (16) and/or the insertion direction (19) extend/s transversely to the direction of a longitudinal extent (24) of the elongated machine frame (1) and transversely to the direction of movement of the baking tongs (3) provided along the endless conveyor (2).

23. The baking oven according to claim 16, wherein the baking oven comprises a second heating element holder (25), and the at least one heating element (6) is connectable to the machine frame (1) at the first heating element holder (14), or at the second heating element holder (25) via the guiding device (15).

24. The baking oven according to claim 16, wherein the baking oven comprises a second heating element holder (25) and at least one additional heating element holder (26), and the at least one heating element (6) is connectable to the machine frame (1) at the first heating element holder (14), at the second heating element holder (25) or at the at least one additional heating element holder (26), via the guiding device (15).

25. The baking oven according to claim 16, wherein the baking chamber (4) is surrounded by a housing (9), the housing (9) comprises flaps (27) that can be opened and closed, the heating element holder (7) is arranged in the area of a flap (27) so that the at least one heating element (6) can be inserted into the baking chamber (4) through the opened flap (27).

26. The baking oven according to claim 24, wherein the baking chamber (4) is surrounded by a housing (9), the housing (9) comprises at least one flap (27) that can be opened and closed, and all the heating element holders (7, 14, 25, 26) are respectively arranged in the area of a flap (27) so that the at least one heating element (6) can be inserted into one of the heating element holders (7, 14, 25, 26) of the baking chamber (4) through the at least one opened flap (27).

27. The baking oven according to claim 16, wherein the at least one heating arrangement (5) comprises a plurality of heating elements (6), a plurality of heating element holders (7, 14, 25, 26) are provided, and the heating elements (6) are releasably connected to the machine frame (1) via guiding devices (15).

28. The baking oven according to claim 16, wherein the endless conveyor (2) extends along an upper transport surface (28) and along a lower transport surface (29) that is vertically spaced away from the upper transport surface (28), and at least one heating element holder (7, 14, 25, or 26) is arranged between the upper transport surface (28) and the lower transport surface (29).

29. The baking oven according to claim 16, wherein the at last one heating element (6) is configured as a gas-powered radiant burner.

30. The baking oven according to claim 16, wherein the at least one heating element (6) is configured as a downwardly directed gas-powered radiant burner.

31. The baking oven according to claim 16, wherein the baking oven comprises at least one upper heating element holder (7) on which an upper heating element is releasably connected to the machine frame (1) via a connection device (8), the baking chamber (4) is surrounded by the housing (9), the housing (9) has an opening (11) in the area of the upper heating element holder (7) that is closed or can be closed by means of a removable lid (10), and the opening (11) is at least partly covered by the upper heating element.

32. The baking oven according to claim 31, wherein the connection device (8) comprises at least one support (12) connected to the machine frame for vertically supporting the upper heating element.

33. The baking oven according to claim 31, wherein the upper heating element is arranged on the removable lid (10).

34. The baking oven according to claim 31, wherein the removable lid (10) is at least partly formed by the upper heating element.

35. A baking oven for producing baked edible products, comprising:
an elongated machine frame (1);
an endless conveyor (2);
a baking chamber (4) including a heating arrangement (5) having at least one heating element (6) for supplying thermal energy to the baking chamber (4);
multiple openable and closable baking tongs (3) arranged in series and provided in the elongated machine frame (1) along the endless conveyor (2), said tongs, one after the other, arranged to proceed through a baking mass application area for applying a baking mass to an opened baking tong (3), a closing area for closing the baking tongs (3), the baking chamber (4) for baking the baked products in the closed baking tongs (3), in which the heating arrangement (5) heats the baking tongs (3) located inside the baking chamber (4), an opening area for opening the baking tongs (3), and a baked product removal area for removing the baked products from the opened baking tongs (3); and
wherein the baking oven comprises a first heating element holder (14) on which the at least one heating element (6) is releasably connected to the machine frame (1) via a guiding device (15), wherein the guiding device (15) has at least one guiding rail (16) and at least one guiding element (17) which is movable along the guiding rail (16).
